(19) United States
(12) Patent Application Publication
(10) Pub. No.: US 2004/0095383 A1
(43) Pub. Date: May 20, 2004

(54) Behavior analysis based optimization of navigation in E-commerce user interfaces

(75) Inventors: Ronald Pfeifer, Nufringen (DE); Gerhard Stenzel, Herrenberg (DE); Kathleen Wolfram, Luedenscheid (DE)

Correspondence Address: IBM CORPORATION, ROCHESTER IP LAW DEPT. 917, 3605 HIGHWAY 52 NORTH, ROCHESTER, MN, 55901-7829, US

(73) Assignee: INTERNATIONAL BUSINESS MACHINES CORPORATION, ARMONK, NY

(21) Appl. No.: 10/601,996

(22) Filed: Jun. 23, 2003

(30) Foreign Application Priority Data
Jun. 27, 2002 (DE) 02014279.0

(51) Int. Cl. G09G 5/00

(52) U.S. Cl. 345/745; 345/746

(57) ABSTRACT

This invention describes a behavior analysis based improvement of presentation in e-commerce user interfaces. It renders user behavior visible which is invisible and unknown to the website owner in prior art. This is mainly achieved by tracking the navigation of each user. Enhancing the path data with which the user finally achieved a particular success; for example, locating or purchasing a product; i.e., enhancing the success user path will supply the web site owner with most of information needed to improve the average user navigation.

### FIELD OF THE INVENTION

The present invention relates to method and system for improving user interfaces of a data processing system like websites, or application programs in which user action is tracked.

### BACKGROUND OF THE INVENTION

The emergence of the Internet has opened up a variety of new fields. One important field is e-commerce. E-commerce comprises activities on the Internet like: retrieving information, using services, downloading software, buying products, etc. E-commerce activities tend to be customer driven; i.e., information, services, products, etc., are provided by an enterprise, and it is then up to the customer to gain access to them.

Retrieving information from a web site is often complicated for a customer. Large websites, for instance, comprise a large “net” of web pages which a website designer has set up on based upon his or her subject view. The structure chosen by the designer and thus the way information is presented to a user; ie, a visitor of the Website, might be very different from what the majority of the web page users may prefer.

Existing prior art tools such as “http-analyzer” or IBM's “WebSphere Site Analyzer,” provide partial solutions by analyzing: page content (e.g. broken links, duplicate pages, excessive load sizes, . . . ) or usage rates (e.g. who is using the page, from where is a page entered, . . . ). While helpful, these tools do not account for actual visitor behavior.

### SUMMARY OF THE INVENTION

With reference to Website improvement, as the main business objective is to sell products or to locate them, it is advantageous for learning about the user's behavior to monitor the buyer's or successful locator's behavior rather than that of a visitor who stops use of the website without having found or purchased a desired product.

This invention describes a behavior analysis based improvement of presentation in e-commerce user interfaces. It renders user behavior visible which is invisible and unknown to the website owner in prior art.

This is mainly achieved by tracking the navigation of each user. Enhancing the path data with which the user finally achieved a particular success; for example, locating or purchasing a product; i.e., enhancing the success user path will supply the web site owner with most of information needed to improve the average user navigation.

The basics of this invention can also be applied to menu analysis and improvement of user interface of each conventional computer program, whether or not a user feedback can be provided to the respective program developer.

The present invention is based on exploiting the fact that it is useful to learn from successful users; i.e., customers of a Website or end-user in an application program.

According to the basic aspect of the present invention a method and respective system is disclosed for analyzing user behavior in a man-machine interface of a data processing system, like websites, desktop, or palmtop application programs in which user action is tracked. Said method is characterized by the steps of:

a) defining at least one success element associated with user navigation within said man-machine interface occurring during a user session,

b) storing user navigation information, which may be associated with said at least one success element, and reflecting the user behavior within said man-machine interface,

c) correlating said at least one success element to said stored user navigation information,

d) process a statistical analysis on a plurality of different sets of navigation information collected in respective different user sessions.

A success element shall be understood as a separate part of the man-machine interface the activation of which lies within the user's intention to do something particular; e.g., purchase a given article on a website or deleting a line of a table within a spread sheet application. For example, a user wants to purchase a pair of trousers, then the button “trousers” might be selected as a success element, or a button “purchase,” or a button specifying a generic term comprising trousers, like “clothes.” The selection what is admissible as a success element for a given analysis is able to be limited and defined by a skilled person utilizing and customizing the inventive analysis tool. Thus, briefly, any part of the user interface the activation of which seems useful for the user to activate within his particular intention can be selected as a success element according to the present invention. Further examples are given further below.

When further, graphically representing results of said statistical analysis in a graph-like form, the presentation is rendered clear and user-friendly, even with an increased amount of result information.

When filtering analysis results according to one or more success elements, a selectable direction can be provided for interpreting the analysis results.

When the stored user navigation information comprises:

a) a success element definition,

b) location information associated with said success element,

c) time information associated with a user action related to said success element, and

d) session information identifier which allows to identify different users,

then a concise form of storing the most important details telling the essentials of the user behavior is found.

User identification information is required when more than one user uses the same IP number, as; e.g., is the case in enterprise networks having a common firewall for a plurality of users.

Said session identifier may be associated with a user when he first enters a Website. Said identifier will then be part of each request issued by this particular user.

When, according to a second aspect of the present invention, user navigation information is collected from user navigation in a user application program, then a different field of use is found for the present invention.

A success element must be defined differently to such used on a specific website, and suited for improvement of the user interface in application programs. For example, single sequences of actions performed from within the menu bar in a desktop application program are tracked and stored as a single “success element.” An example is “View-side-layout-Zoom-two pages” (which is assumed to enable for a book-like display of two pages facing each other).

The improvement can be used basically in two different ways:

First, for improving the man-machine interface of a local copy of the application program, and

second, for improving a next release issued by the producer of the application program.

In the second case, the navigation data is collected from a plurality of users and is evaluated centrally at the program producer's site. Navigation data can be silently tracked, transparent to the user. When the user is online, the collected data can be accessed by the producer easily (assumed the user agrees to that).

When improving the interface for a local copy of an application program only; ie, the first case above, the preferred way is to design the application program such that it adapts its user interface automatically to “the main roads” the individual user walks along. For this purpose, prior art programming technique can be used.

The application program can be constructed advantageously to comprise the following:

after a predetermined level of collected navigation data has been achieved

a) changing the man-machine interface such that user preferences are displayed in an emphasized way within the user interface, and/or

b) at least parts of the non-preferred rest of said man-machine interface is displayed in a background way; ie, is hidden completely or partly behind a button the activation of which makes such non-preferred rest of features visible again.

Of course, different techniques of “hiding” can be applied as well, as they are known from prior art menu technique.

It should be noted that the above improvement of user interfaces in application programs is the more relevant the smaller the display area is which is available to the user. Thus, for example in small, hand-held devices, as; e.g., palm computers, mobile phones, organizers and the like, the before-mentioned particular aspect of the present invention may be advantageously applied.

The following advantages can thus be achieved according to the invention:

A quick method of getting information telling many details of the user behavior is provided.

Further, a cheap method of monitoring the user's behavior is provided, e-commerce and application programs will become more user-friendly, the customer satisfaction will be enhanced, and analysts of websites and application programs interfaces and marketing specialists can be easily provided with information they hadn't had access to before.

The described tracking and analysis mechanism can be applied advantageously in all cases where success elements can be defined and the user's navigation and interaction behavior can be tracked and temporarily saved, and all collected data can be returned to the service/program provider.

### BRIEF DESCRIPTION OF THE DRAWINGS

The present invention is illustrated by way of example and is not limited by the shape of the figures of the drawings in which:

FIG. 1 is a schematic representation illustrating the basic steps of the control flow of the preferred embodiment.

FIG. 2 is a schematic representation illustrating the basic analysis steps of the preferred embodiment.

FIG. 3 is a schematic representation illustrating three different exemplary segments of user paths.

FIG. 4 is a simplified schematic graph representation of analysis results obtained according to the preferred embodiment.

### DETAILED DESCRIPTION OF THE PREFERRED EMBODIMENT

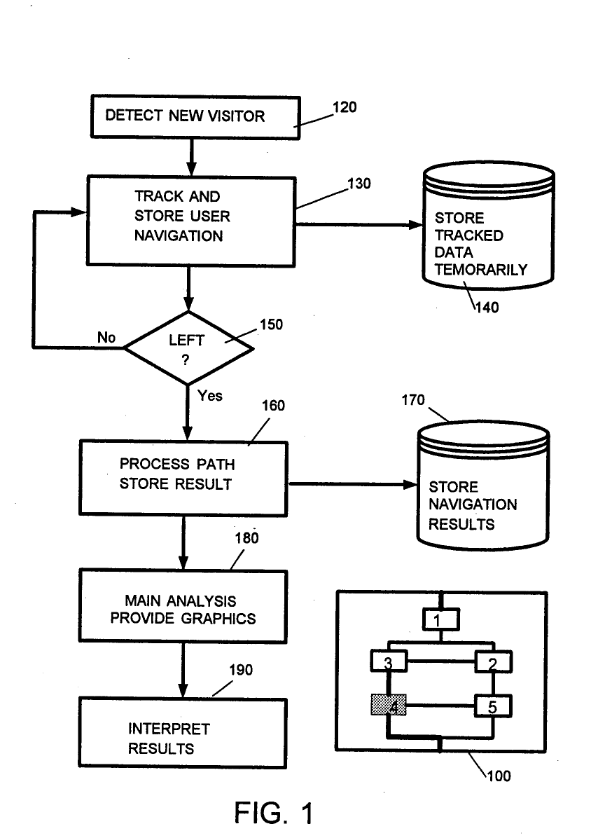

With general reference to the figures and with special reference now to FIG. 1 the preferred embodiment is described in more detail for analyzing user behavior in websites.

The website is supposed to offer particular products and to comprise a plurality of web pages which are linked multiply with each other.

The preferred embodiment uses a resident active program which is permanently monitoring the access of users to the website. A new visitor is detected in step 120.

This is partly known from prior art monitoring programs which at least count the number of visitors of a website and display this number to the attention of the visitor himself. The preferred embodiment, however, goes far beyond that, which is described as follows:

The path; ie, the way the user takes during navigating within said website is tracked precisely, step 130:

According to the embodiment all events and requests issued by the user by way of using the man-machine interface are stored temporarily in a database, step 140.

In addition to what is gathered by prior art tools; however, the preferred embodiment derives from the URL, referring URL or a timestamp a particular “success element”—dataset in the following way:

Data (Success element; location; Time).

Further, it might be necessary to log particular session parameters as well. This will be described later below.

Examples illustrating the usability of a button or the like for to be used as a success element are as follows:

button “Put in shopping basket” (1;product number;_)

Pressing the button “Put in shopping basket” is regarded as a success action. Once the button is pressed by the customer, the value of “1” is generated in a session log file generated by the preferred embodiment. The user is a customer who is buying a certain product. The preferred embodiment thus has to get a feedback information what product has been selected by the user. This is provided to the system by prior art program technique as an information which is present due to the fact that the particular product was marked by the user before the button was pressed. In this case, the exact time doesn't matter and is thus not stored.

button “Next page” (1;text ID;1 min)

Assuming a web page contains text that customers are keen to read, and reading this text could thus be interpreted as a success action, if the customer has rested for about a minute plus minus some tolerance on this page before clicking on the “Next page”-button. This shows that “success” can be defined very context-sensitive.

Button “Back” (0;_;_)

The “Back”-button should not be counted as a success action. Neither time nor product number nor something else are relevant in this case.

Thus, any user action can be tracked and stored.

An access log file preferably logs the requests incomimg from the Browser to the Webserver. A log entry indicates if the access was successful and how many bytes were transferred. Further, the time is logged which can be evaluated by the present invention.

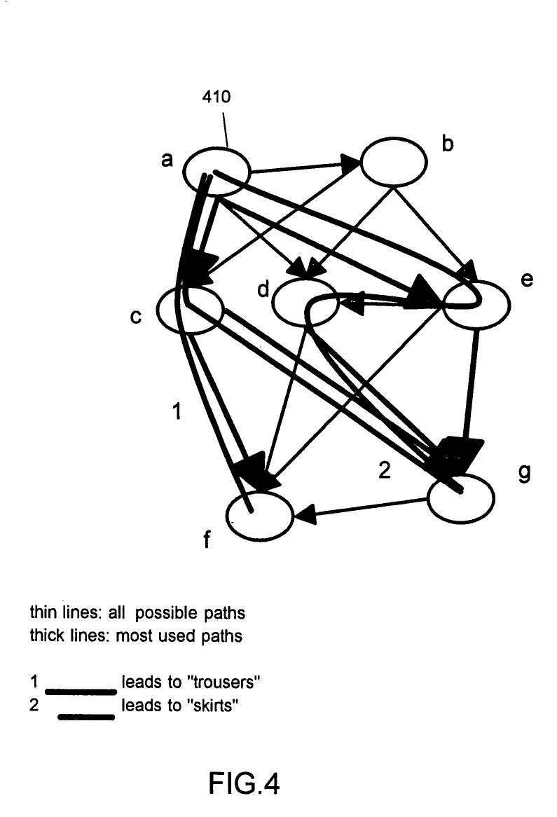

With additional reference to FIG. 4 a portion of an exemplary access log file generated for the user session according to the invention could comprise the data as follows:

A path connecting web pages a, c, and f, each depicted as circles with start page a (410), ie, a->c->f may thus comprise the following information:

127.0.0.1 - - [02/Apr/2002:15:42:19 +0200] “GET /shop/a.html
HTTP/1.1” 304 -
127.0.0.1 - - [02/Apr/2002:15:42:23 +0200] “GET /shop/c.html?id=1234
HTTP/1.1” 200 553
127.0.0.1 - - [02/Apr/2002:15:42:24 +0200] “GET
/shop/f.html?id=1234&action=buy&item=skirt HTTP/1.1” 200 109

As reveals from the above sequence of access log entries, time information, and the before-mentioned success information, here for example ““GET /shop/f.html?id=1234&action=buy&item=skirt HTTP/1.1”” is provided for statistical analysis, and notifying to the evaluation algorithm that a skirt was selected as a buy item, ie, was successfully selected by the user for purchase.

The path a->e->d->g yields:
127.0.0.1 - - [02/Apr/2002:15:42:30 +0200] “GET /shop/a.html
HTTP/1.1” 304-
127.0.0.1 - - [02/Apr/2002:15:42:33 +0200] “GET /shop/e.html?id=1234
HTTP/1.1” 200 581
127.0.0.1 - - [02/Apr/2002:15:42:35 +0200] “GET /shop/d.html?id=1234
HTTP/1.1” 200 547
127.0.0.1 - - [02/Apr/2002:15:42:36 +0200] “GET
/shop/g.html ?id=1234&action=buy&item=trouser HTTP/1.1” 200 109

Here similar behavior, trespassing via pages a, e, d, and g results in a successful purchase of a pair of trousers.

As can be seen from the above tracking data, the amount of data is very large, as this is only a small fraction of a user session record. Thus, it is useful to record only such data the evaluation of which leads to significant results.

Thus, the before-mentioned dataset “Data (Success element; location; Time)” is regarded as sufficient for the most relevant evaluations of user behavior data.

With reference back to FIG. 1, it is permanently checked if the user has left the website, step 150. In the No Branch of a respective decision it is branched back for continuing the tracking of the single user behavior data. In the Yes case thereof the data analysis of the preferred embodiment is triggered by the system in order to analyze the data freshly tracked and stored. This includes in particular to analyze the path, along which the user has navigated through the website, step 160. When ready, the single user analysis results, including success events, paths, or segments of them, are stored in a separate database, step 170.

From there, all similar results can be accessed and subjected to an inventive analysis procedure in order to get information about the way in which the successful user has navigated through the site. In this main analysis step 180 different kinds of success elements can be entered by a person skilled in the art, in order to set the analysis focus according to an individual evaluation goal. Thus, the selection of the success elements used for analysis is modified accordingly. For example, when the website offers clothes, a success element can be added which is represented by pressing a button: “buy this pair of trousers”.

After the analysis including any statistical evaluation which seems to be appropriate to undertake, has completed, the results are present advantageously in a graphical form to a skilled web designer, who may interpret the results, step 190 and improve the navigational structure of the website.

A sample part of the analysis result is depicted with a graphic denoted by reference sign 100. The thick lines connecting pages 3, 4, and exit represent the main road (statistically determined majority) of the successful visitor type.

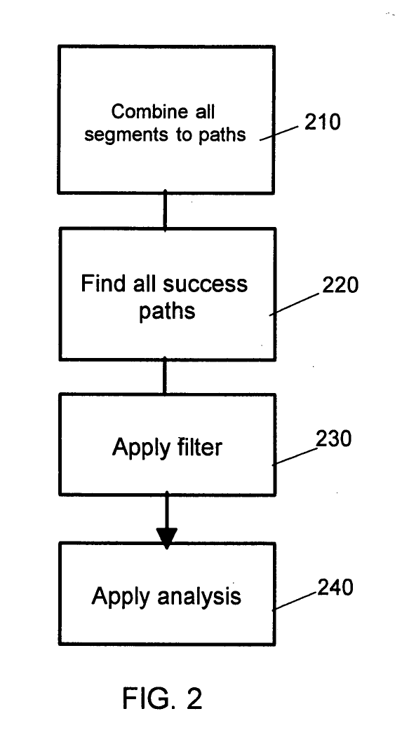

The most basic analysis steps performed by the preferred embodiment are depicted in FIG. 2.

The above-mentioned tracked data associated with a plurality of users who have navigated through the website are analyzed to find out the successful user, and the way in which the majority of them managed it to buy something (buying as an example for “success”).

In particular, in a step 210 all segments are combined to paths, as the segments are stored isolated from each other.

Then, in a step 220 all success paths are found by identifying them due to predetermined success criteria. Said criteria can be known before starting the analysis, or they can be modified or even defined at a later time, when the analysis is performed.

Further, in an optional filtering step 230, undesired—may be too long—paths of successful users are filtered out, in order to concentrate on the successful and straight-forward success paths.

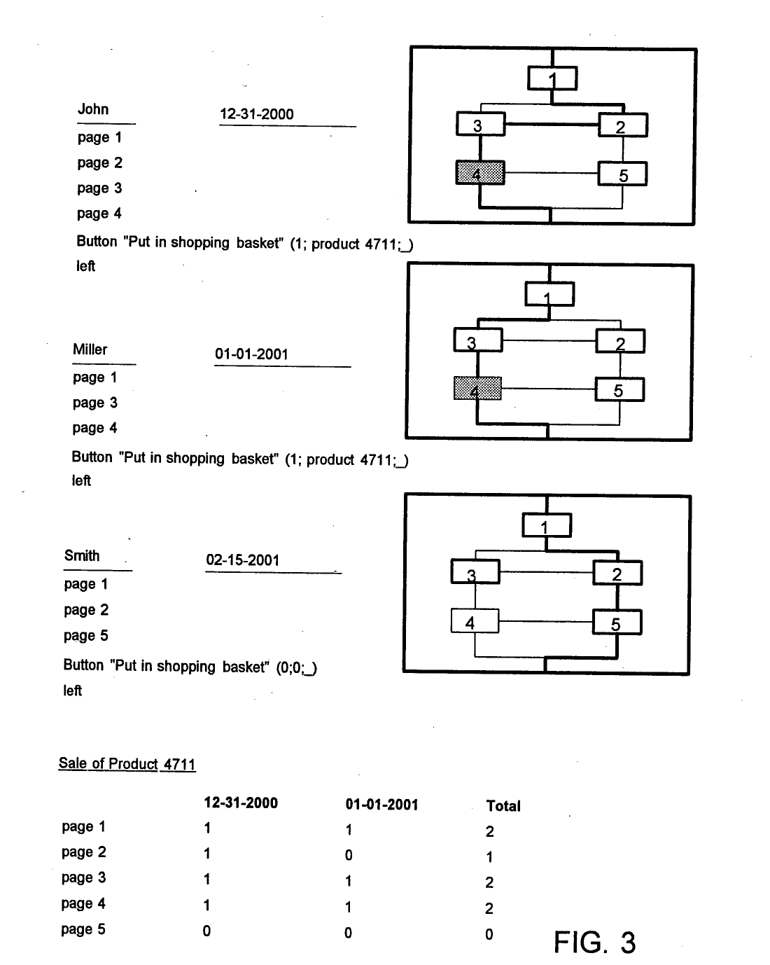

Amongst them, the actual statistical analysis is applied, step 240. Such statistical analysis may comprise the fractions of successful users who navigated through a given respective path. For example, those as depicted schematically and simplified in FIG. 3.

The paths of three users John, Miller and Smith are given in the drawing, together with the sequence in which the single pages 1 to 5 were visited by them. The taken path is depicted in bold printed lines. The users John and Miller are interpreted as successful because they had a product with a given number “4711” in their shopping basket and left after having been in page 4, which is considered to be the key page in view of “successful” purchase, although they entered differently, pages 1-2-3-4 for John and 1-3-4 for Miller. Smith had nothing in his shopping basket and is thus treated as unsuccessful. According to a preferred aspect of the invention this path is excluded from the statistical analysis.

The table depicted at the bottom of FIG. 3 is generated according to the invention revealing the most important data of the successful users. Thus, an analysis result is obtained which renders visible the behavior of user navigation which was invisible until now in prior art.

It should be noted that by virtue of the present invention a suited restructuring of the website can be undertaken of which at least one essential creative input is the before-mentioned analysis result. Thus, for example after careful analyzing the analysis result and comparing the main roads taken by most users to the current website shape, maybe a reason can be found, why unsuccessful user Smith did not enter either of pages 3 or 4, the pages which were visited by the successful users. Maybe an important link was displayed at the wrong place, or too small, or with a misleading context, etc. Thus, the design of this exemplary page 2 can possibly improved in order to avoid a misleading of potential purchasers.

With additional reference to FIG. 4 a preferred representation of results is the graph form. The circles represent pages and the arcs or connecting lines represent transitions from one page to another, which a user has undertaken. A common entry page is assumed to be circle 410.

Thin lines represent possible paths, whereas the thick lines represent the most used paths.

The slash-dotted broken line represents a path leading to a successful purchase of trousers, whereas the dotted lines represents a path leading to a purchase of a skirt, which are both events which are assessed as successful, for the analysis of the present invention.

Thus, as it may be appreciated by a skilled reader, even in larger and more complicated graphs, according to the invention the main road taken by most of the users for purchasing a pair of trousers is a, c, f. That for purchasing a skirt is not a unique path, instead, there are the following:

A, c, g, and a, e, d, g, and a, e, g.

Thus, a re-design of the web site in order to simplify the access to purchase of skirts could be considered as a useful measure.

Further, when it is intended to include complete paths to the analysis, and in particular when time information is difficult to evaluate or is not present in the access log, the source page and the target page in a page transition must be known to the system. For this purpose, a so-called “referer log file” is generated according to a preferred aspect of the invention.

With the same reference to FIG. 4 it might look as follows:

referer.log
Path a->c->f:
- -> /shop/a.html
http://localhost/shop/a.html -> /shop/c.html
http://localhost/shop/c.html?id=1234 -> /shop/f.html
Path a->e->d->g:
- -> /shop/a.html
http://localhost/shop/a.html -> /shop/e.html
http://localhost/shop/e.html?id=1234 -> /shop/d.html
http://localhost/shop/d.html?id=1234 -> /shop/g.html

Thus, the current page as well as the target page is comprised of each entry in the “referrer log file”.

As should reveal from the above description, an essential aspect of the present invention is to do more than just to collect usage and content data, but, instead, relate these data to the customer type in terms of “successful” customers and “unsuccessful” customers. A feedback of the results to a person re-designing the website can advantageously provided to him in a clear and compressed form, which presents essential information on user navigation behavior. This feedback can be repeated after certain time and allows thus web page providers to optimize their net of web pages.

Further, the proposed method cannot only be used in terms of analyzing web sites but also in terms of analyzing navigation in computer programs. One way of returning data collected during the analysis of a computer program comprises to store this information in a log data file hidden to the user. The log file stores similar information as described above in context with navigation on websites, except that the content of store information tells the evaluating person details about user navigation in his application program. Next time the user logs in at the program provider's home page, for example, the hidden and locally stored log file is automatically retrieved. Then the contents of said file is automatically evaluated by a respective analysis tool dedicated here fore according to the present invention, in order to provide a “customized” application program user interface which is specifically adapted to this individual user's needs. Then, the user is asked if he wants to accept this customized version, and if he accepts, a respective patch file or amended executable file will be provided; e.g., online to the user. In this user interface, the user will see only the basic user controls the use of which is usually required to him. This reflects the usual case that daily work in an application program consists to a major part; e.g., more than 90%, in always repeatedly occurring procedures. Thus, the rest of user controls corresponding to said remaining 10% nearly never used user controls can be pushed in the background which improves usability of the program.

An alternative way to individual user-interface adaptation can be achieved without replacing an executable file by an adapted one by programming the user interface in a way which takes in account the main roads taken by the user. When, for example, in the file menu, some items are never used in a given time interval, they are pushed in the background as well. Thus, a built-in counter and evaluation mechanism attached to any important user control is an appropriate means for dynamically adapting the user-interface to the actual needs of a user. Of course, the remaining background user controls representing said 10% of work, can be re-activated, for example, just by pressing a button dedicated to this functionality.

The present invention can be realized in hardware, software, or a combination of hardware and software. A tool according to the present invention can be realized in a centralized fashion in one computer system, or in a distributed fashion where different elements are spread across several interconnected computer systems. Any kind of computer system or other apparatus adapted for carrying out the methods described herein is suited. A typical combination of hardware and software could be a general-purpose computer system with a computer program that, when being loaded and executed, controls the computer system such that it carries out the methods described herein.

The present invention can also be embedded in a computer program product, which comprises all the features enabling the implementation of the methods described herein, and which—when loaded in a computer system—is able to carry out these methods.

Computer program means or computer program in the present context mean any expression, in any language, code or notation, of a set of instructions intended to cause a system having an information processing capability to perform a particular function either directly or after either or both of the following:

a) conversion to another language, code or notation;

b) reproduction in a different material form.

What is claimed is:

1. A method for analyzing user behavior in a man-machine interface of a data processing system in which user action is tracked, characterized by the steps of:
a) defining at least one success element associated with user navigation within said man-machine interface occurring during a user session,
b) storing user navigation information associated with said at least one success element and reflecting the user behavior within said man-machine interface,
c) correlating said at least one success element to a respective number of user navigation information, and
d) performing a statistical analysis on a plurality of different sets of navigation information collected in respective different user sessions.

2. The method according to claim 1 in which user navigation information is collected from user navigation when visiting a Website.

3. The method according to claim 1, further comprising the step of graphically representing results of said statistical analysis in a graph-like form.

4. The method according to claim 1, further comprising the step of filtering analysis results according to one or more success elements.

5. The method according to claim 1 in which said stored user navigation information comprises:
a) a success element definition,
b) location information associated with said success element,
c) time information associated with a user action related to said success element, and
d) session information identifier which allows to identify different users

6. The method according to claim 1 in which user navigation information is collected from user navigation in a user application program.

7. The method according to claim 6, further comprising the step of:
after a predetermined level of collected navigation data has been achieved, changing the man-machine interface such that user preferences are displayed in an emphasized way.

8. The method according to claim 6, in which at least parts of the non-preferred rest of said man-machine interface is displayed in a background way.

9. A computer-readable program stored on a computer-readable medium, said computer readable program being configured to perform the steps of:
a) defining at least one success element associated with user navigation within said man-machine interface occurring during a user session,
b) storing user navigation information associated with said at least one success element and reflecting the user behavior within said man-machine interface,
c) correlating said at least one success element to a respective number of user navigation information, and
d) performing a statistical analysis on a plurality of different sets of navigation information collected in respective different user sessions.

10. The computer-readable program of claim 1 in which user navigation information is collected from user navigation when visiting a Website.

11. The computer-readable program of claim 1, further comprising the step of graphically representing results of said statistical analysis in a graph-like form.

12. The computer-readable program of claim 1, further comprising the step of filtering analysis results according to one or more success elements.

13. The computer-readable program of claim 1 in which said stored user navigation information comprises:
a) a success element definition,
b) location information associated with said success element,
c) time information associated with a user action related to said success element, and
d) session information identifier which allows to identify different users

14. The computer-readable program of claim 1 in which user navigation information is collected from user navigation in a user application program.

15. The computer-readable program of claim 6, further comprising the step of: after a predetermined level of collected navigation data has been achieved, changing the man-machine interface such that user preferences are displayed in an emphasized way.

16. The computer-readable program of claim 6, in which at least parts of the non-preferred rest of said man-machine interface is displayed in a background way.
